(19) United States
(12) Patent Application Publication
(10) Pub. No.: US 2013/0307969 A1
(43) Pub. Date: Nov. 21, 2013

(54) Method for Safely Identifying a Vehicle Captured by a Radiation Sensor in a Photograph

(71) Applicant: Jenoptik Robot GmbH, Monheim (DE)

(72) Inventor: Christoph Gebauer, Koeln (DE)

(73) Assignee: JENOPTIK Robot GmbH, Monheim (DE)

(21) Appl. No.: 13/996,362

(22) PCT Filed: Dec. 15, 2011
(86) PCT No.: PCT/DE2011/075310

§ 371 Date: Jul. 24, 2013

(30) Foreign Application Priority Data
Dec. 23, 2010 (DE) 10 2010 056 406.0

(51) Int. Cl. G08G 1/054

(52) U.S. Cl. CPC G08G 1/054
USPC 348/135

(57) ABSTRACT

Method for securely identifying in an image recording (1) a vehicle (2) acquired by a radiation sensor, wherein the driving track traveled by the vehicle is determined from obtained measurement data pertaining to the position of the vehicle, this driving track being extrapolated over the image recording (1) and inserted into the image recording (1). A representative length of the vehicle is advantageously determined from obtained measurement data pertaining to speed and to the duration over which measurement data are acquired, and the driving track which is inserted into the image recording (1) is interrupted over the representative length starting at the photo point.

### RELATED APPLICATIONS

The present application is a U.S. National Stage application of International PCT Application No. PCT/DE2011/075310 filed on Dec. 15, 2011 which claims priority benefit of German Application No. DE 10 2010 056 406.0 filed on Dec. 23, 2010, the contents of each are incorporated by reference in their entirety.

### FIELD OF THE INVENTION

Invasive and noninvasive sensors which monitor road traffic in a narrow monitoring area, e.g., covering only one lane, within a section of road are known in traffic monitoring (e.g., induction loops, piezo strips, laser sensors and radar sensors). Assigning the acquired measurement data to one of the vehicles giving rise to these measurement data is made less problematic in this way.

### BACKGROUND OF THE INVENTION

In recent years, noninvasive sensors which cover a broad monitoring area, e.g., several traffic lanes, within a section of road have become increasingly established. Sensors of this kind are radiation sensors, particularly radiation sensors for laser radiation or radar radiation, whose sensor region forms the monitoring area which, in contrast to invasive sensors, is not directly visible in the image recording but which covers a portion of the roadway so as to be invisible to the human eye. In order to assign the acquired measurement data to one of the vehicles engendering these measurement data, the vehicles passing through the sensor region are measured at a plurality of measurement times, which is also referred to as “tracking” (e.g., EP 2 048 515 A1 or DE 10 2007 038 364 A1).

The term “tracking” is understood within the context of the invention in a very general way to mean the repeated acquisition of measurement data relating to position which change during the passage through a sensor region.

The tracking data obtained during tracking of an object are a sequence of measurement data, including measurement data relating to position, which are associated in each instance with individual measurement times, the interval between measurement times being determined by the repetition frequency of the measurement or acquisition. The tracking data of a vehicle driving through a sensor region of a radiation sensor describe the driving track defined by the vehicle when passing through the sensor region such that the tracking data can be used to identify the measured vehicle. Usually, the vehicle can be associated with a particular lane, e.g., through knowledge of the driving track, and thus identified in an image recording of a traffic scene.

The measurement data obtained at each measurement time depend upon the type of measurement sensor.

By “measurement data” is meant within the context of the invention not only the data obtained by direct measurement, but also those data which can be derived computationally from the data obtained directly through measurement.

Sensors suitable for tracking are those that can acquire the position and change in position such as radar sensors, laser scanners and video cameras with light-sensitive receiver elements arranged in a two-dimensional manner, also known as matrix receivers, e.g., CCD sensors or C-MOS sensors.

DE 10 2007 022 373 A1 discloses a method for detecting traffic infractions through acquisition of object tracking data by means of a radar sensor which directs a radar beam onto the roadway such that a plurality of vehicles can simultaneously drive through a measurement region (hereinafter sensor region) defined by the radar beam (radar lobe). To this end, a radar device can be positioned next to the roadway or above the roadway, e.g., fastened to a bridge.

The relative speed of an object in relation to the radar sensor, the distance of the surfaces of the object reflecting the radar radiation from the radar sensor, and the angle at which the reflected radar radiation impinges on the radar sensor in relation to the radar axis can be derived from the reflected radar signals.

In a continuous radar sensor upon which DE 10 2007 022 373 A1 is based, a continuous speed measurement or a continuous distance measurement is carried out using the Doppler radar effect and the principle of frequency shift keying (FSK) in evaluating the phase difference of reflected radar signals of different frequencies. Angle measurement is carried out, e.g., by means of two receiving antenna by a triangulation measurement. Accordingly, at every measurement time—by which is meant a time window within which measurement data are acquired—a value triplet comprising radial velocity, distance and angle (E(t); V(t); γ(t)), is given for each vehicle in the radar cone, the individual values being formed, e.g., by averaging over a family of measured values of partial reflections according to a Rayleigh distribution such as occur particularly for distance and angle.

The measurements are taken over a time period of approximately 100 ms to several seconds depending on the vehicle speed between entry into and exit from the radar cone, e.g., within an interval of 20 ms, so that the vehicle tracks (hereinafter driving track) described by the measured vehicle can be determined with high accuracy.

The value triplets determined by the radar sensor, together with an associated measurement time, are then attributed to a respective vehicle number (this does not refer to the license number of the vehicle), an entry time and an exit time and are fed to a computer (hereinafter tracking data).

If a speed in excess of a specified speed limit has been detected during the measurement, the computer determines the driving track of the respective violating vehicle using the tracking data and sends a signal to a camera for taking a picture (image recording) of the current traffic scene. The camera is so arranged at a known, fixed distance from the radar device and so adapted that the optical axis (hereinafter camera axis) is oriented in a fixed angular relationship to the radar axis, and the traffic scene is sharply imaged over a depth of focus at a specified distance which is referred to as photo point.

Since the object field of the camera not only extends over all lanes along which the radar cone (sensor region) is also directed, but is generally larger, vehicles which are not yet, or no longer, located in the radar cone at the time that the camera is triggered can also be imaged in the recording.

In order to identify the measured vehicle in the image unambiguously, the driving track of the measured vehicle determined by measurement techniques is inserted into the image. The insertion is carried out in such a way that a marking representing the driving track is superimposed over the image points in the image which are to be associated in the object field with the positions which are defined by distance and angle and which collectively form the driving track. In other words, the identification takes place solely on the basis of the driving track that is measured relative to the radar device without absolute reference to individual lanes of the roadway.

In DE 10 2007 022 373 A1, the marking of the driving track can be inserted in the form of image points, e.g., dots, crosses, triangles or the like, or in the form of a line or surface area. The insertion can be effected by coloring or by brightening or darkening the appropriate image areas. A tolerance range around the actual measurement data can also be indicated.

A plurality of evidence photographs can be taken during passage of a vehicle which show this vehicle at various positions of the detected driving track.

In addition to problems of accurate measurement data acquisition which depend upon the type of sensor and owing to which the driving track of a vehicle can be determined only with a certain degree of inaccuracy, problems are also experienced through the fact that vehicles driving behind one another can be associated with the same driving track inserted into the evidence photograph. As a result, a measured vehicle cannot be identified within a group of imaged vehicles in every case.

### OBJECTS OF THE INVENTION

The object of the invention is to find a method by means of which a vehicle detected by tracking is identified in an image recording with greater certainty.

In a method for securely identifying in an image recording a vehicle acquired by a radiation sensor, wherein measurement data pertaining to the speed and position of a vehicle are acquired at a plurality of measurement times over the duration of the passage of the vehicle through the sensor region of a radiation sensor, an image recording of an object area comprising the sensor region is made by means of a camera when the measured vehicle is located at a given photo point, the driving track traveled by the vehicle is determined from the measurement data pertaining to position, and this driving track is inserted into the image recording, the object of the invention is met in that, through the use of the measurement data pertaining to position, the determined driving track is extrapolated beyond the sensor region and is inserted into the image recording.

The driving track is advantageously extrapolated over the entire object area and inserted into the image recording.

It is further advantageous when the measurement data pertaining to position, to speed and to the period for which the measurement data are acquired are used to determine a representative length of the vehicle, and the driving track which is inserted into the image recording is interrupted over the representative length by an interruption where a vehicle is located in the image recording on the imaged driving track. The interruption of the inserted driving track advantageously starts at the photo point.

The driving track is advantageously inserted in the form of a bright stripe over the imaged roadway.

It is also advantageous when an auxiliary stripe is imaged at an offset to the stripe over the length of the interruption.

### BRIEF DESCRIPTION OF THE DRAWINGS

The invention will be described more fully in the following in an embodiment example referring to the annexed drawings. The drawings show:

FIG. 1a is an image recording with a passenger car;

FIG. 1b is a drawing of an image recording according to FIG. 1a;

FIG. 2a is an image recording with a truck;

FIG. 2b is a drawing of an image recording according to FIG. 2a.

### DESCRIPTION OF THE EMBODIMENTS

Any radiation sensor known from the prior art which, as was described in the introductory part, acquires measurement data pertaining to speed and position of a vehicle at a plurality of measurement times as the vehicle passes through the sensor region of the radiation sensor can be used to carry out the method.

In particular, laser scanners or radar sensors such as those mentioned in the description of the prior art can be used. They are oriented with respect to the edge of the roadway and roadway surface in a manner familiar from known generic methods for speed measurement such that their sensor region, which is determined in the case of a radar sensor by the radar cone and in the case of a laser scanner by the scanning angle region thereof, covers a portion of the roadway preferably so as to extend over all lanes.

The object field of the camera must at least partially cover the sensor region.

The proportional relationship between the object field of the camera, determined by the aperture angle of the camera, and the sensor region varies for different radiation sensors depending on type.

In radar sensors in which only distance values can be derived as position values from the measurement data, the radiating angle is usually about 5° so that on principle the radar cone is narrower than the object field of a camera which generally has an aperture angle of about 20°.

In radar sensors in which distance values and angle values can be acquired as measurement data for the position, the radiating angle is between 20° and 40°, for example, so that the radar cone can have approximately the same width as the object field of the camera.

As is set forth at length in the prior art, the scanning angle region of a laser scanner comprises a dead zone around the scanning axis in which no measurement data are received that are usable for deriving speed, for which reason these measurement data are not evaluated. If the camera is so oriented with respect to the laser scanner that they both include at least portions of the scanning angle region in which usable measurement data for deriving a speed are received, the dead zone is included in the object field.

Now if, as is likewise known from the prior art and as is stated in the description of the prior art, the driving track traveled by the vehicle is determined from the measurement data for the derived position and if this driving track is inserted into an image recording that has been made beforehand at a triggering time during the passage of a vehicle through the object area of a camera that at least partially includes the sensor region, the inserted driving track covers only the area in the image recording that corresponds to the imaged sensor region. Particularly if the imaged sensor region along the imaged roadway is not substantially wider than the length of a vehicle, only the vehicle is covered insofar as the triggering time lies between entry into the sensor region and exit from the sensor region. Accordingly, information about the vehicle could be lost. If the triggering time occurs at a point in time after the measured vehicle has passed through the sensor region, the inserted driving track is located behind the imaged, measured vehicle in the image recording. If further vehicles are pictured in the image recording, it could happen that the driving track is not assigned unequivocally to the measured vehicle so that the driving track does not lead to unequivocal identification of the measured vehicle.

According to the invention, the inserted driving track is imaged so as to be lengthened through extrapolation, i.e., beyond the region that can be calculated using the measurement data pertaining to position. This lengthening is preferably carried out over the entire image recording.

In order that the measured vehicle is not covered by the imaged driving track and in order to obtain an additional confirmation for the measured vehicle, a representative length of the vehicle is advantageously determined from the measurement data pertaining to position, from which the length of road between entry and exit can be determined, as well as from the measurement data pertaining to the speed and the duration over which the measurement data are acquired, and the inserted driving track is interrupted corresponding to the representative length at the location of the imaged, measured vehicle, i.e., the photo point.

Particularly when the radiation sensor is a radar sensor, the length of road traveled by a vehicle between entry and exit differs depending on the range of distance from the radar sensor in which the vehicle passes through the radar cone; it is for this reason that knowledge of the length of road is required for determining a representative length of the vehicle with knowledge of the duration over which the measurement data are acquired and of the speed by means of the distance-time law.

The duration over which measurement data are acquired is limited by a first measurement time and a last measurement time at which the radiation of the radiation sensor is reflected at a respective vehicle.

The photo point is known in that the triggering time occurs after a predetermined time delay after the first acquisition of measurement data, i.e., after entering in case of oncoming traffic, or after the last acquisition of measurement data, i.e., after exiting in case of receding traffic. The time delay is short enough that a different speed of the vehicles, particularly when it is a question of detecting speed violations where the possible difference in speed between different vehicles is more sharply delimited, has only a negligible effect on the position of the measured vehicle in the image recording. In other words, the photo point and, therefore, the position of the imaged, measured vehicles in the image recording differs substantially only when the vehicles describe different driving tracks, which applies especially when the vehicles drive on different lanes.

It will be clear to the person skilled in the art that the computationally determined driving track and the lengthened driving track which is developed therefrom in an image through extrapolation and which is determined by the relative position of the optical axis of the camera in relation to the sensor axis (such as the radar axis or scanning axis), the image scale and the distortion of the camera objective must be converted in order to insert the driving track into the image recording so as to fit the imaged object field.

The inserted driving track is advantageously projected on the roadway surface as a stripe or an interrupted stripe which appears distinctly different than the roadway surface in terms of brightness. Brightening is a particularly advantageous manner of depiction.

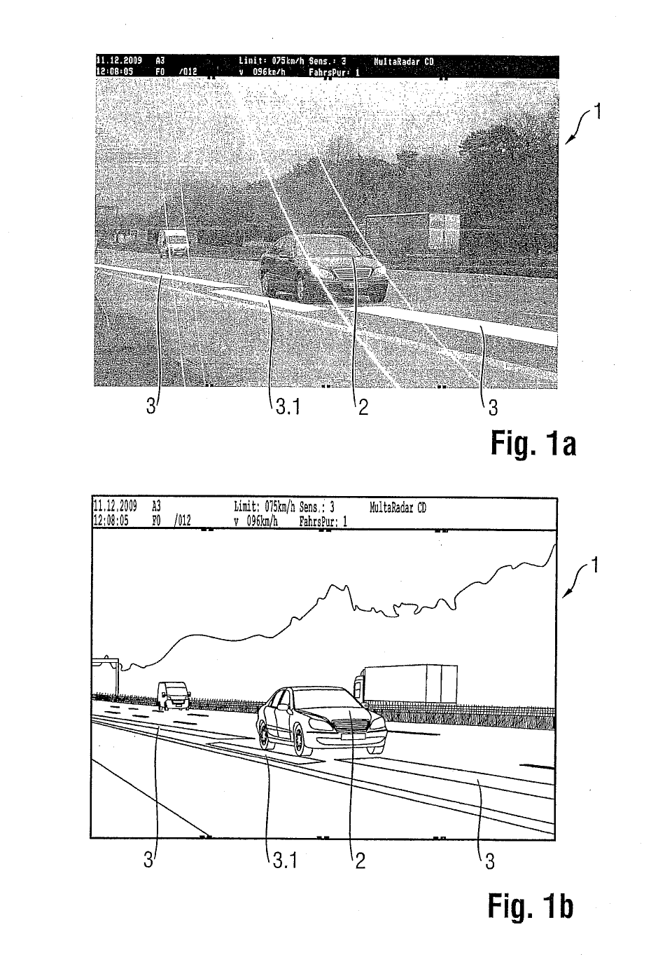

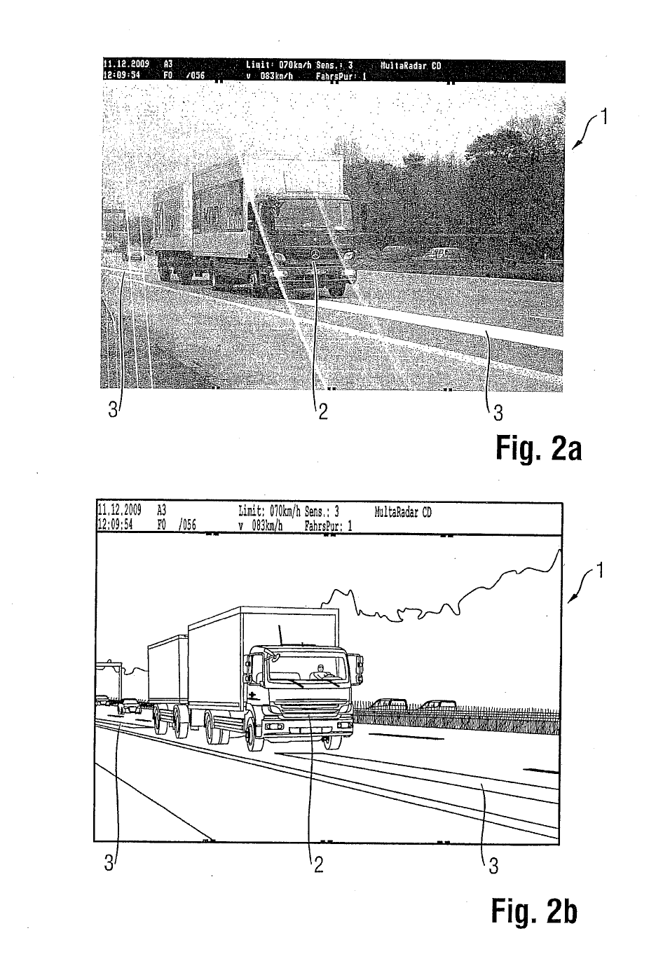

FIGS. 1 and 2 show, respectively, an image document with a data panel and an image recording 1 in which is imaged at least one vehicle 2 driving on a roadway. The roadway appears brighter in front of and behind the vehicle 2 imaged at a given photo point along a stripe 3 which is interrupted by the vehicle 2 and which represents the driving track. The length of the section of roadway over which the stripe 3 is interrupted corresponds to a length characterizing the imaged vehicle 2. This section advantageously starts at the photo point for the measured vehicle 2.

As is depicted in FIG. 1, an auxiliary stripe 3.1 can be depicted at an offset to the driving track next to the imaged vehicle 2 along the section in which the stripe 3 is interrupted, this auxiliary stripe 3.1 having a length identical to the interrupted section.

By means of the method according to the invention, an image recording 1 is made which more clearly distinguishes a measured vehicle 2 imaged in the image recording 1 as the vehicle 2 being measured compared to the prior art.

### LIST OF REFERENCE NUMERALS

1 image recording

2 vehicle

3 stripe

3.1 auxiliary stripe

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. Method for securely identifying in an image recording a vehicle acquired by a radiation sensor comprising, acquiring measurement data pertaining to the speed and position of a vehicle at a plurality of measurement times over the duration of the passage of the vehicle through a sensor region of the radiation sensor, making an image recording of an object area comprising the sensor region by means of a camera when the measured vehicle is located at a given photo point, determining a driving track traveled by the vehicle from the measurement data pertaining to position, said driving track being inserted into the image recording and, using the measurement data pertaining to position, the determined driving track is extrapolated beyond the sensor region and is inserted into the image recording.

2. Method according to claim 1, wherein the driving track is extrapolated over the entire object area and inserted into the image recording.

3. Method according to claim 2, wherein the measurement data pertaining to position, to speed and to the duration over which the measurement data are acquired are used to determine a representative length of the vehicle, and the driving track which is inserted into the image recording is interrupted over the representative length by an interruption at that location where a vehicle is located in the image recording on the imaged driving track.

4. Method according to claim 3, wherein the interruption of the inserted driving track starts at the photo point.

5. Method according to claim 3, wherein the driving track is inserted in the form of a bright stripe over the imaged roadway.

6. Method according to claim 3, further comprising projecting an auxiliary stripe over the length of the interruption at an offset to said stripe.
